(19) United States
(12) Patent Application Publication
(10) Pub. No.: US 2026/0143255 A1
(43) Pub. Date: May 21, 2026

(54) FIXED PATTERN NOISE CALIBRATION AND CORRECTION FOR VIDEO NOISE REDUCTION

(71) Applicant: Samsung Electronics Co., Ltd., Suwon-si (KR)

(72) Inventors: Zhiyuan Mao, Frisco, TX (US); John William Glotzbach, Allen, TX (US); Enyu Cai, Mountain View, CA (US); John Seokjun Lee, Allen, TX (US); Hamid Rahim Sheikh, Allen, TX (US)

(21) Appl. No.: 18/949,537

(22) Filed: Nov. 15, 2024

(51) Int. Cl. H04N 25/67

(52) U.S. Cl. CPC H04N 25/67

(57) ABSTRACT

A method includes of fixed pattern noise (FPN) reduction includes capturing, at runtime by an image sensor of an electronic device, noisy calibration video frames, and for each noisy calibration video frame: denoising, by a processor of the electronic device, the noisy calibration video frame to obtain a denoising residue frame, and determining, by the processor, whether the denoising residue frame is suitable for aggregation based on motion of the noisy calibration video frame relative to a previously captured noisy calibration video frame. The method further includes calibrating, by the processor, an FPN map for the image sensor based on an aggregation of the denoising residue frames that are determined to be suitable for aggregation, after the calibrating, capturing, by the image sensor, noisy target video frames, and generating, by the processor, clean target video frames from the noisy target video frames based on the calibrated FPN map.

### TECHNICAL FIELD

This disclosure relates generally to image processing systems. More specifically, this disclosure relates to a fixed pattern noise calibration and correction for video noise reduction.

### BACKGROUND

As integrated cameras in mobile devices (such as smartphones) have become ubiquitous and high quality, users of mobile devices have come to expect high performance from the integrated cameras under various conditions. In low-light scenarios, however, it is challenging to capture a clean video with sharp details due to the strong noise presented. There are two types of noise in a low-light video: random noise and fixed pattern noise (FPN). Random noise originates from the stochastic nature of the image acquisition process and is hence spatially and temporally varying. FPN results from imperfections in the camera sensor manufacturing process and is temporally stable.

Existing noise reduction algorithms in video image signal processing (ISP) relies on temporal blending and spatial noise reduction algorithms to remove noise, both of which are designed for random noise. Temporal blending cannot remove FPN since FPN is temporally invariant. Spatial noise reduction (SNR) algorithms need a stronger setting to remove spatially correlated FPN, which will hurt the video details. Traditionally, the most effective way to remove FPN is via pre-calibration. A pre-calibration process requires capturing videos in a pre-determined environment for each individual camera sensor, which poses practicality challenges in device production.

### SUMMARY

This disclosure relates to a method and system for fixed pattern noise (FPN) calibration and correction for video noise reduction.

In a first embodiment, a method of FPN reduction performed by an electronic device includes capturing, at runtime by an image sensor of the electronic device, noisy calibration video frames, and for each noisy calibration video frame: denoising, by a processor of the electronic device, the noisy calibration video frame to obtain a denoising residue frame, and determining, by the processor, whether the denoising residue frame is suitable for aggregation based on motion of the noisy calibration video frame relative to a previously captured noisy calibration video frame. The method further includes calibrating, by the processor, an FPN map for the image sensor based on an aggregation of the denoising residue frames that are determined to be suitable for aggregation, after the calibrating, capturing, by the image sensor, noisy target video frames, and generating, by the processor, clean target video frames from the noisy target video frames based on the calibrated FPN map.

In a second embodiment, an electronic device for performing FPN reduction comprises an image sensor and a processor operably coupled with the image sensor. The image sensor is configured to capture, at runtime, noisy calibration video frames. The processor is configured to, for each noisy calibration video frame: denoise the noisy calibration video frame to obtain a denoising residue frame, and determine whether the denoising residue frame is suitable for aggregation based on motion of the noisy calibration video frame relative to a previously captured noisy calibration video frame. The processor is further configured to calibrate an FPN map for the image sensor based on an aggregation of the denoising residue frames that are determined to be suitable for aggregation. The image sensor is further configured to, after the calibrating, capture noisy target video frames. The processor is further configured to generate clean target video frames from the noisy target video frames based on the calibrated FPN map.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates example image frames and showing FPN removal in accordance with this disclosure;

FIG. 3 illustrates an example FPN map calibration process in accordance with this disclosure;

FIG. 4 illustrates example calibrated FPN maps and in accordance with this disclosure;

FIG. 5 illustrates example calibrated FPN maps and in accordance with this disclosure;

FIG. 6 illustrates an example motion-based aggregation decision process in accordance with this disclosure;

FIG. 7 illustrates an example FPN correction process in accordance with this disclosure;

FIG. 8 illustrates example calibrated FPN maps and in accordance with this disclosure;

FIG. 9 illustrates an example FPN map calibration process using a dark calibration video in accordance with this disclosure;

FIG. 10 illustrates example calibrated FPN maps and in accordance with this disclosure; and

FIG. 11 illustrates an example method for FPN calibration and correction for video noise reduction in accordance with this disclosure.

### DETAILED DESCRIPTION

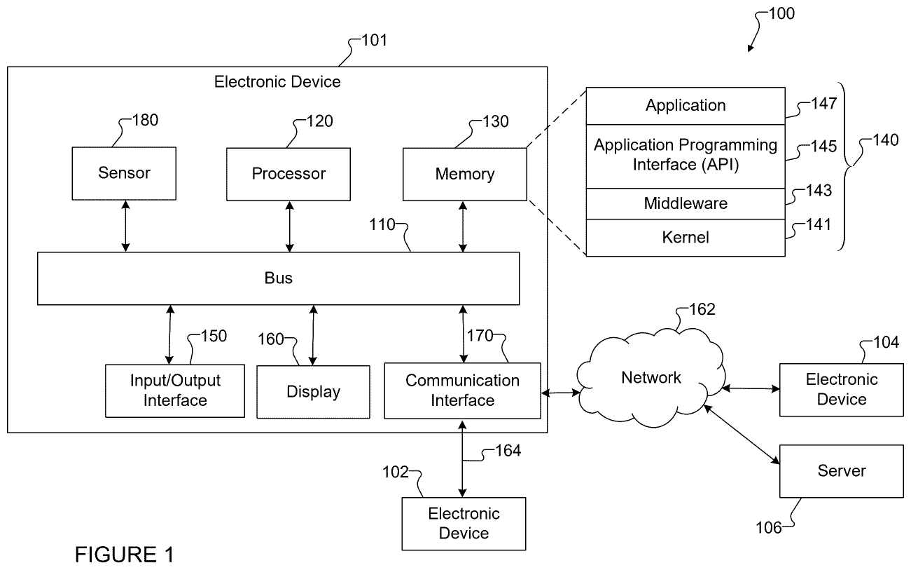

FIGS. 1 through 11, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, as integrated cameras in mobile devices (such as smartphones) have become ubiquitous and high quality, users of mobile devices have come to expect high performance from the integrated cameras under various conditions. In low-light scenarios, however, it is challenging to capture a clean video with sharp details due to the strong noise presented. There are two types of noise in a low-light video: random noise and fixed pattern noise (FPN). Random noise originates from the stochastic nature of the image acquisition process and is hence spatially and temporally varying. FPN results from imperfections in the camera sensor manufacturing process and is temporally stable.

Existing noise reduction algorithms in video image signal processing (ISP) relies on temporal blending and spatial noise reduction algorithms to remove noise, both of which are designed for random noise. Temporal blending cannot remove FPN since FPN is temporally invariant. SNR (or denoising) algorithms need a stronger setting to remove spatially correlated FPN, which will hurt the video details. Traditionally, the most effective way to remove FPN is via pre-calibration. A pre-calibration process requires capturing videos in a pre-determined environment for each individual camera sensor, which poses practicality challenges in device production.

Embodiments of the present disclosure include systems and methods for removing FPN, thereby improving the performance of video noise reduction algorithms in low-light conditions. These embodiments work with or without a factory calibration step. As these embodiments effectively correct the FPN, they also reduce dependence on SNR algorithms and lead to improvement in the details of the video.

Note that while some of the embodiments discussed below are described in the context of use in consumer electronic devices (such as smartphones), this is merely one example. It will be understood that the principles of this disclosure may be implemented in any number of other suitable contexts and may use any suitable device or devices.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to FPN calibration and correction for video noise reduction. For example, as described below, the processor 120 may receive and process inputs (such as noisy calibration video frames and noisy target video frames) from an image sensor, and perform FPN map calibration for the image sensor and FPN correction of the noisy target video frames using the inputs. The processor 120 may also instruct other devices to perform certain operations (such as performing the FPN map calibration or the FPN correction) or display content on one or more displays 160.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to FPN calibration and correction for video noise reduction. For example, the application 147 includes one or more applications supporting the receipt of noisy calibration video frames and noisy target video frames, performing FPN map calibration for the image sensor based on the noisy calibration video frames, and performing FPN correction on the noisy target video frames based on the calibrated FPN map resulting from the FPN map calibration. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to machine learning speaker verification. For example, as described below, the server 106 may receive and process inputs (such as noisy calibration video frames and noisy target video frames received from an image sensor of the electronic device 101) and perform FPN map calibration for the image sensor and FPN correction of the noisy target video frames using the inputs. The server 106 may also instruct other devices to perform certain operations (such as performing the FPN map calibration or the FPN correction) or display content on one or more displays 160.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

Existing video processing pipelines have no modality for FPN correction, and instead rely on strong SNR settings to reduce FPN. As noted above, current FPN correction algorithms require a factory calibration step, or are computationally expensive. By removing the FPN, it is possible to simultaneously keep more image detail and remove more noise in smooth regions.

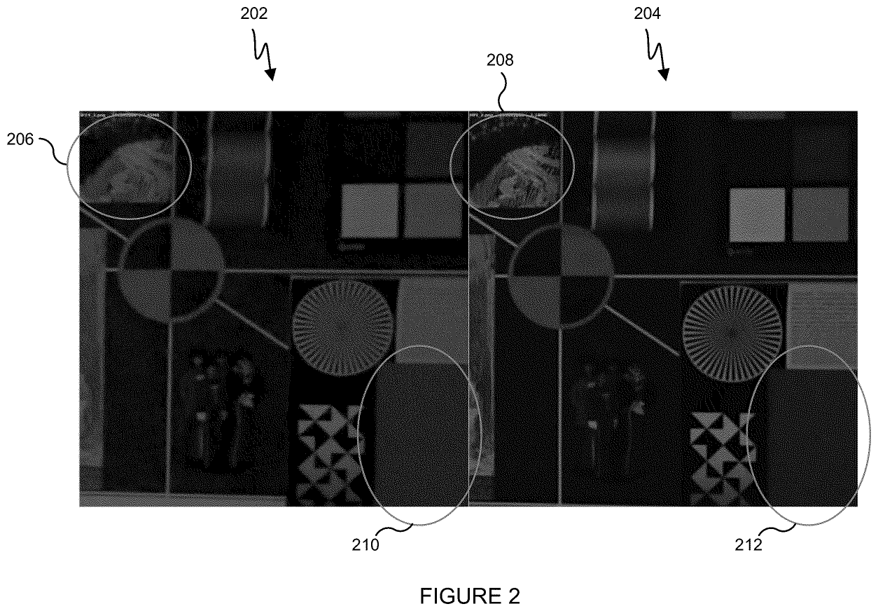

FIG. 2 illustrates example image frames 202 and 204 showing FPN removal in accordance with this disclosure. In FIG. 2, image frame 202 is processed using a baseline video processing pipeline, and image frame 204 is processed using a video processing pipeline that incorporates FPN correction based on embodiments of the present disclosure. As shown in FIG. 2, the detailed region 208 of image frame 204 has more image detail than the detailed region 206 of image frame 202—that is, FPN correction keeps more image detail than the baseline video processing pipeline. At the same time, the smooth region 212 of image frame 204 has less noise than the smooth region 210 of image frame 202—that is, FPN correction removes more noise in smooth regions than the baseline video processing pipeline.

Embodiments of the present disclosure include a runtime algorithm to estimate (or calibrate) an FPN map for an image sensor while a video is being recorded using the image sensor. When a standard video denoising pipeline is run on the video to obtain clean frames, a denoising residue is calculated by subtracting each clean frame from the corresponding noisy input frame. The residues from each calibration video frame will be accumulated (or aggregated) using, e.g., a running average, and FPN map calibration will be complete once a sufficient number of residue frames have been accumulated. Since FPN is temporally invariant, a pre-calibrated FPN map can be subtracted from frames of a video captured at runtime to substantially remove FPN from the frames.

Embodiments of the present disclosure also include a process for guiding the FPN map calibration using video motion information. If the system were to naively average all denoising residues, then the calibrated FPN map could contain undesired image structure edges due to imperfect denoising. That is, if the same image structure is present in each residue, then the calibrated FPN map resulting from naively averaging the residues would still include the undesired image structure information. In this scenario, using the calibrated FPN map to denoise video frames would introduce image artifacts into the denoised video frames. To reduce the leakage of video content structures into the calibrated FPN map, residues may only be accumulated when there is sufficient motion of the camera between calibration frames from which the residues are derived. Undesired image structure information is averaged out as continuous averaging takes place, yielding a high quality final video frame when the resultant calibrated FPN map is used for FPN correction.

A calibrated FPN map generated in this manner may contain shading due to the contents of the scene in the calibration video. Shading in calibrated FPN map could cause problems during FPN correction, and affect the image quality when applying the calibrated FPN map to other videos captured with the image sensor. Accordingly, embodiments of the present disclosure include a shading correction step to remove shading from denoising residues before accumulating them.

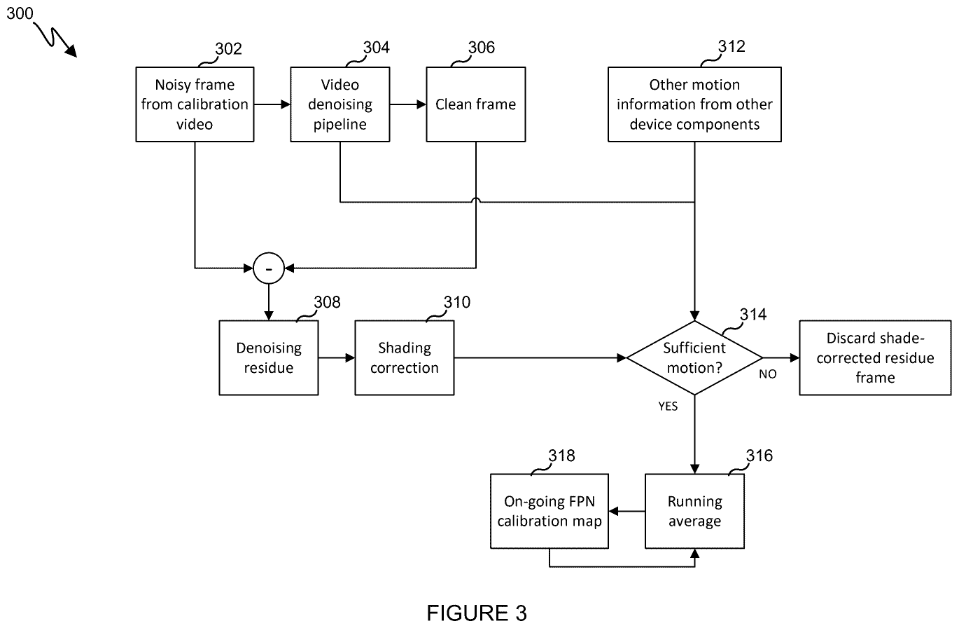

FIG. 3 illustrates an example FPN map calibration process 300 in accordance with this disclosure. For case of explanation, the process 300 is described as involving the use of the electronic device 101 in the network configuration 100 of FIG. 1. However, the process 300 may be used with any other suitable electronic device (such as the server 106) or a combination of devices (such as the electronic device 101 and the server 106) and in any other suitable system(s). For the process 300 a user records a calibration video using an image sensor of the electronic device 101 to calibrate an FPN map for the image sensor. Each frame of this video is sequentially pushed into the pipeline of process 300 to calibrate the FPN map.

Noisy calibration video frames 302 captured using the image sensor may be raw or demosaiced (e.g., in a color space such as YUV or RGB). As shown in FIG. 3, each noisy calibration frame 302 is passed through a video denoising pipeline 304 to obtain a corresponding clean calibration frame 306. The video denoising pipeline 304 may be a standard denoising pipeline. A denoising residue frame 308 is calculated by subtracting the clean calibration frame 306 from the noisy calibration frame 302.

The denoising residue frame 308 is then passed through a shading correction procedure 310 to obtain a shade-corrected residue frame. The shading correction procedure 310 may include, in some embodiments, calculating a shade component of each residue frame 308 by running an average filter on the down-sampled residue, and then up-sampling back to the original resolution. For example, the shading correction procedure 310 may downsample the denoising residue frame 308 (for YUV format, downsampling 8× for the Y channel and 4× for the U and V channels, or downsampling 8× across all channels for RGB or raw formats), then run a strong (at least 7×7) average filter on the downsampled residue frame. The filtering result may then be upsampled back to the original resolution to obtain the shade component of the denoising residue frame 308, which is subtracted from the denoising residue frame 308 to obtain the shade-corrected residue frame. The shading correction procedure 310 ensures that the pixels of the resultant calibrated FPN map locally have zero means (i.e., no part of the map is brighter or darker than another), and thus will not affect the brightness and color of the final frame when applied to other videos for FPN correction.

Meanwhile, motion information for a given calibration frame may include motion data 312 obtained from other device components (e.g., calculated from gyro data provided by a sensor in the electronic device 101), motion vectors, or global homography (available from video ISPs). This motion information is used to make an aggregation decision (at decision block 314) for the shade-corrected residue frame corresponding to that calibration frame—that is, whether sufficient motion is detected between the calibration frame and the previous calibration frame (or frames) to average out undesired image structure information if the shade-corrected residue frame is accumulated into the FPN map.

If sufficient motion is detected at decision block 314, then the shade-corrected residue frame is accumulated (or aggregated) at block 316 into the on-going FPN calibration map 318. In this example, block 316 performs a running average of the shade-corrected residue frames included in the on-going FPN calibration map 318. After a sufficient number of shade-corrected residue frames have been accumulated into the on-going FPN calibration map 318, a final calibrated FPN map is obtained.

In some embodiments, the operations of blocks 302-308 are performed in hardware, while the operations of blocks 310-318 are performed in software.

Although FIG. 3 illustrates one example of an FPN map calibration process 300, various changes may be made to FIG. 3. For example, the process 300 may also be performed using a distributed architecture. For instance, capture of the noisy calibration video frames may be executed on a client electronic device (such as electronic device 101) and a server (such as server 106) may perform some or all of the calculations related to calibrating the FPN map.

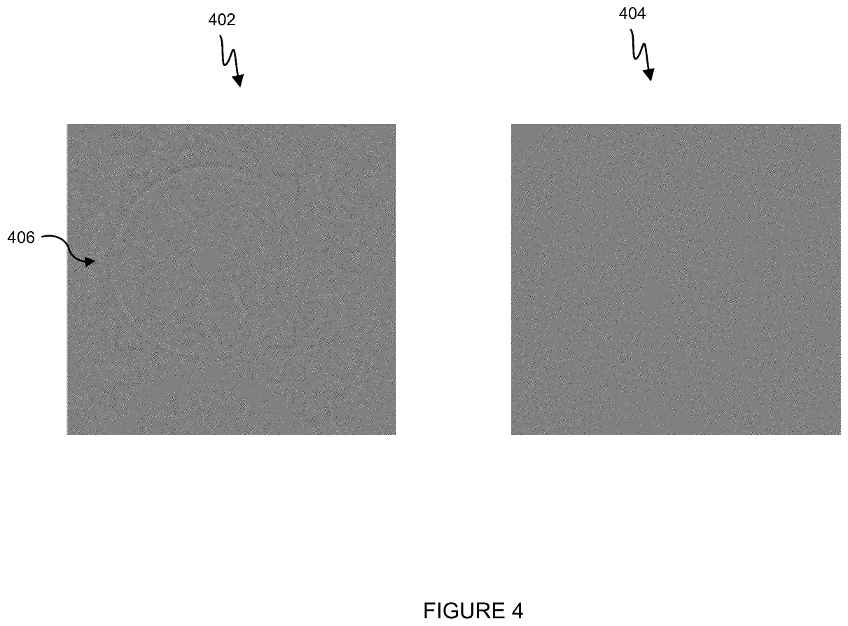

FIG. 4 illustrates example calibrated FPN maps 402 and 404 in accordance with this disclosure. In the examples of FIG. 4, a calibration video (captured, e.g., according to blocks 302-308 of the process 300 of FIG. 3) includes image content that is not fully removed by the standard video denoising pipeline (e.g., video denoising pipeline 304). Accordingly, the resulting denoising residue frames 308 will contain both FPN and undesired image structure information (i.e., noise that is not related to FPN). As noted above, to obtain a high quality calibrated FPN map, there should be sufficient motion between each aggregated residue frame to remove such undesired image structure information.

The example calibrated FPN map 402 is obtained from a static calibration video (i.e., a calibration video with little or no motion of the image sensor between aggregated residue frames). As a result, the calibrated FPN map 402 includes undesired image structure information 406, which is an artifact of contents of the scene captured in the calibration video.

By contrast, the example calibrated FPN map 404 is obtained from a panning calibration video (i.e., a calibration video with significant motion of the image sensor between aggregated residue frames). The panning calibration video may capture the same scene as the calibration video used to obtain the example calibrated FPN map 402. However, due to the motion of the image sensor between each captured calibration video frame, no undesired image structure information remains in the calibrated FPN map 404. The calibrated FPN map 404 represents only the FPN of the image sensor (i.e., it is a high quality FPN map).

As discussed above with respect to FIG. 3, motion information for the image sensor may be used to determine to discard denoising residue frames unless the image sensor has moved sufficiently between the last aggregated residue frame and the current residue frame, so that the undesired image structure information 406 is averaged out in the running average aggregation. This allows a high quality calibrated FPN map to be obtained even when there is not enough movement between every frame of a calibration video to average out any undesired image structure information.

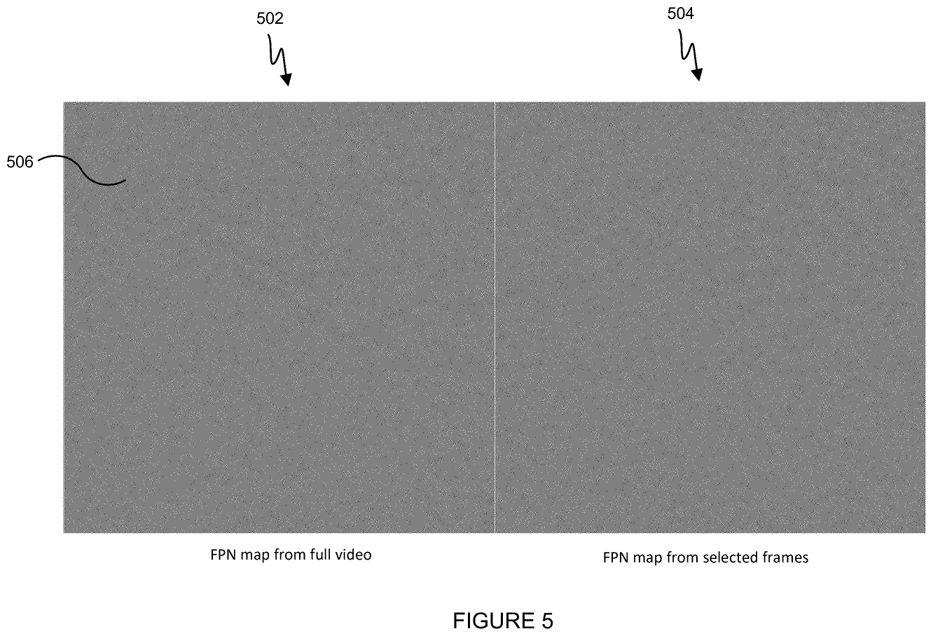

FIG. 5 illustrates example calibrated FPN maps 502 and 504 in accordance with this disclosure. In the examples of FIG. 5, similar to the examples of FIG. 4, undesired image structure information is contained in the denoising residue frames of a captured calibration video. In the examples of FIG. 5, the same calibration video, which has a small amount of motion of the image sensor between each captured frame, is used to obtain both of the example calibrated FPN maps 502 and 504.

The example calibrated FPN map 502 is obtained from the full calibration video by, e.g., aggregating all of the denoising residue frames obtained from the calibration video frames). The motion of the image sensor between each captured calibration video frame is insufficient to average out undesired image structure information, and thus the example calibrated FPN map 502 contains undesired image structure information 506, which is an artifact of contents of the scene captured in the calibration video.

The example calibrated FPN map 504 is obtained using only selected frames from the calibration video by, e.g., aggregating only denoising residue frames for which there is sufficient motion of the image sensor between capture of the corresponding calibration video frames. These frames may be selected using the motion data and aggregation decision procedure of blocks 312-314 of FIG. 3. As a result, no undesired image structure information remains in the calibrated FPN map 504.

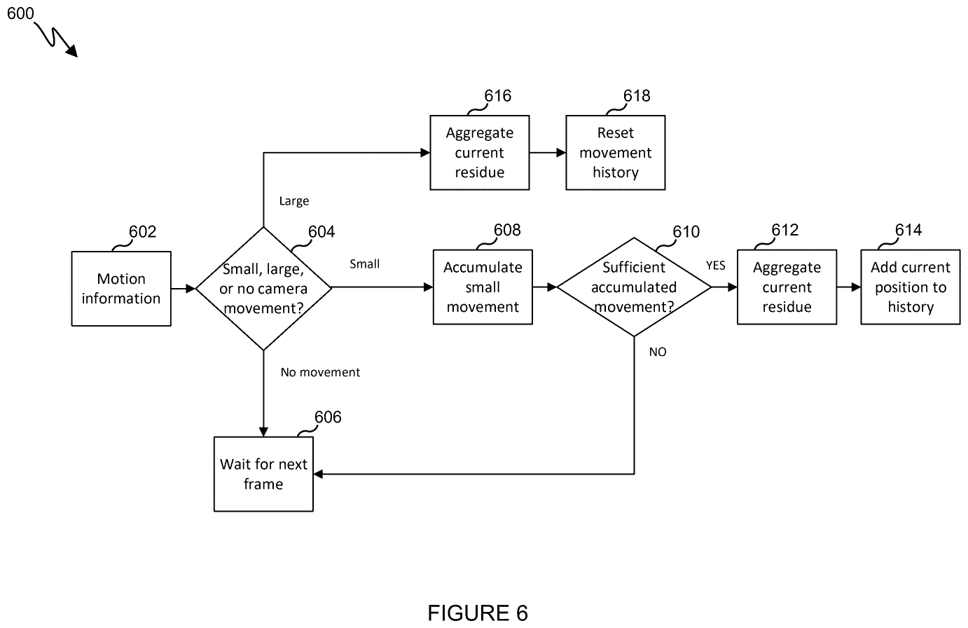

FIG. 6 illustrates an example motion-based aggregation decision process 600 in accordance with this disclosure. The process 600 may, for example, be used to obtain the calibrated FPN map 504 of FIG. 5. For ease of explanation, the process 600 is described as corresponding to the blocks 312-318 in the FPN map calibration process 300 of FIG. 3, involving the use of the electronic device 101 in the network configuration 100 of FIG. 1. However, the process 600 may be used in any other suitable FPN map calibration process and with any other suitable device.

In the example of FIG. 6, the process 600 uses real-time camera movement information (motion information 602), such as a global homography matrix, motion vectors, or gyro data, to make decisions as to whether to aggregate the current denoising residue frame (i.e., use it for the run-time average). The result of this process is that undesired image structures in the denoising residue frames are prevented from being retained in the final calibrated FPN map.

The motion information 602 may include the motion data 312 obtained from other device components as well as motion data derived from the video denoising pipeline 304 in FIG. 3. Decision block 604 detects the amount of camera movement between the current denoising residue frame and the previous denoising residue frame (i.e., the change in position of the image sensor between capture of the calibration frame corresponding to the previous denoising residue frame and capture of the calibration frame corresponding to the current denoising residue frame).

If there is no camera movement detected at decision block 604, then the process discards the current residue frame and waits for the next residue frame (block 606).

If there is small local motion of the camera detected at decision block 604 (a predetermined amount that is insufficient for aggregation, e.g., less than 3 pixels), then the process adds the detected amount of motion to an accumulator (at block 608) and checks (at decision block 610) whether the total amount of motion in the accumulator is sufficient for aggregation (e.g., between 3 and 8 pixels). If the amount of accumulated motion is insufficient, then the process discards the current residue frame and waits for the next residue frame (block 606). If the amount of accumulated motion is sufficient, however, then the process aggregates the current residue frame (at block 612) and adds the current position to a position history tracker (at block 614). Keeping track of the local position history of the aggregated frames avoids repeatedly aggregating residue frames at the same location.

If there is a large motion of the camera detected at decision block 604 (a predetermined amount that is considered a perspective change, e.g., greater than 8 pixels), then the current residue frame is directly aggregated (at block 616) and the position history tracker is reset (at block 618).

In some embodiments, the denoising residue aggregation is performed with a running average. This may be represented by the following operations, where β is an iteration counter initialized to 1.

$$FPN = ( 1 - \frac{1}{β} ) * FPN + \frac{1}{β} * CurrentResidue ; \\ β = β + 1 ;$$

A pre-calibrated FPN map, once obtained as described herein above, can be used at run-time to remove FPN from video frames of a target video captured in a current recording session using the image sensor that corresponds to the pre-calibrated FPN map. However, the characteristics of FPN in the target video frames may differ slightly from the pre-calibrated FPN map due to, e.g., lighting conditions and camera parameters that differ from those of the calibration video used to obtain the pre-calibrated FPN map. Accordingly, embodiments of the present disclosure match the statistics of the pre-calibrated FPN map and currently recorded target video frames (by, e.g., minimizing the cross-correlation between them). The FPN in a target video frame can then be removed by subtracting the statistically-matched pre-calibrated FPN map from the target video frame.

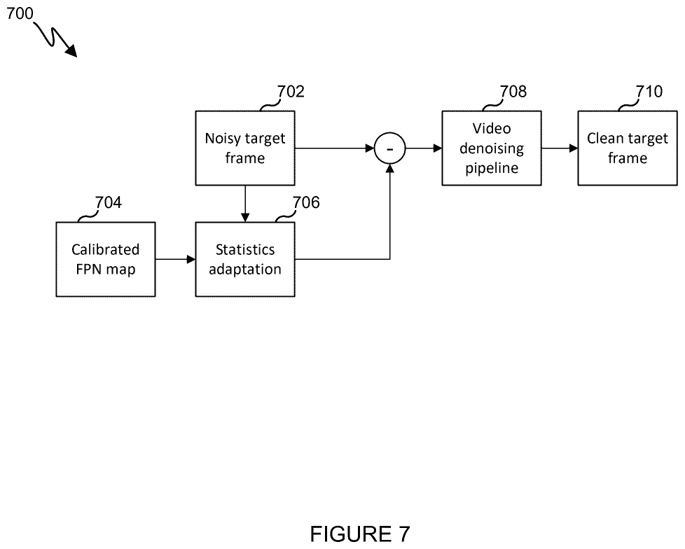

FIG. 7 illustrates an example FPN correction process 700 in accordance with this disclosure. For ease of explanation, the process 700 is described as involving the use of the electronic device 101 in the network configuration 100 of FIG. 1. However, the process 700 may be used with any other suitable electronic device (such as the server 106) or a combination of devices (such as the electronic device 101 and the server 106) and in any other suitable system(s). The process 700 is understood to take place after calibration has been performed (e.g., according to the process 300 of FIG. 3) to obtain a pre-calibrated FPN map 704 for the image sensor of the electronic device 101. For the process 700 a user records a video of interest (i.e., a target video) using the image sensor of the electronic device 101, and each frame of this video is sequentially pushed into the pipeline of process 700 to correct the FPN in the frame.

Each noisy target video frame 702 captured using the image sensor is provided to a statistics adaptation procedure 706 with the pre-calibrated FPN map 704. The statistics adaptation procedure 706 matches the statistics of the pre-calibrated FPN map 704 to the FPN of the current recording session. The result is a current FPN map for use with the noisy target video frame 702.

In some embodiments, the statistics adaptation procedure 706 uses a scalar modulation of the pre-calibrated FPN map 704 to match the pre-calibrated FPN with the FPN of the current recording session. This may be represented as follows.

$$CurrentFPN = α * CalibratedFPN \qquad ( 1 )$$

where the scaling factor α is used to account for the difference between the FPN of the calibration video and the FPN of the current recording session.

In some embodiments, the scaling factor α can be obtained by minimizing the cross-correlation between the FPN-corrected target video frame and the pre-calibrated FPN map 704. If FPN is perfectly removed from the FPN-corrected target video frame, then it will have zero cross-correlation with the pre-calibrated FPN map 704. This may be represented by the following equations.

$$XCORR ( I - α * C , C ) = 0 \qquad ( 2 )$$

$$α = \frac{sum ( I * C )}{sum ( C * C )} \qquad ( 3 )$$

where the noisy target video frame 702 is denoted as I, the pre-calibrated FPN map 704 is denoted as C, and the * operator denotes element-wise multiplication.

In equation (2), the term I−α*C is in the image space, while C is in the noise space. To potentially improve the robustness of the FPN statistics matching by avoiding the impact of image content on the FPN statistics, the scaling factor α can instead be obtained by minimizing the cross-correlation between the FPN-corrected target denoising residue frame and the pre-calibrated FPN map 704. This may be represented by the following equations.

$$XCORR ( I - α * C - SNR ( I - α * C ) , C ) = 0 \qquad ( 4 )$$

$$α = \frac{sum ( ( I - SNR ( l ) ) * C )}{sum ( C * C )} \qquad ( 5 )$$

This formulation be efficiently implemented in a system in which SNR(I) is readily available.

In other embodiments, the scaling factor α can be obtained by first calculating a denoising residue frame for the noisy target video frame 702, as described above with respect to blocks 302-308 of FIG. 3. The denoising residue frame may optionally be downsampled (e.g., by 8×) to reduce computation cost. The downsampled denoising residue frame may then be thresholded using the inverse Q-function to minimize the impact of image structures on the FPN statistics. This may be represented by the following equations.

$$Threshold = Qinv ( 0.01 ) * std ( Residue ) \qquad ( 6 )$$

$$Residue * ( \vert Residue \vert > Threshold ) = sign ( Residue ) * Threshold \qquad ( 7 )$$

A coarse proxy (i.e., an estimation) of the FPN of the target video may then be obtained as a running average of thresholded denoising residue frames of the target video, as represented by the following operations, where β is an iteration counter initialized to 1.

$$ProxyFPN = ( 1 - \frac{1}{β} ) * ProxyFPN + \frac{1}{β} * Residue \\ β = β + 1 ;$$

After this, the scaling factor α can be calculated by matching the standard deviations of the pre-calibrated FPN map and the estimated FPN of the target video. This may be represented by the following equation.

$$α = \frac{std ( ProxyFPN )}{std ( CalibratedFPN )} \qquad ( 8 )$$

After the current FPN map is calculated in block 706, it may be subtracted from the noisy target video frame 702, and the resulting FPN-corrected target video frame is passed to the video denoising pipeline 708, which outputs a clean target video frame 710. The video denoising pipeline 708 may be a standard video denoising pipeline.

In some embodiments, all operations of process 700 are performed in hardware.

Although FIG. 7 illustrates one example of an FPN correction process 700, various changes may be made to FIG. 7. For example, the process 700 may also be performed using a distributed architecture. For instance, capture of the noisy target video frames may be executed on a client electronic device (such as electronic device 101) and a server (such as server 106) may perform some or all of the calculations related to performing statistics adaptation and FPN correction.

In the above embodiments, the FPN map calibration process takes advantage of random camera motions during recording of the calibration video to remove undesired image structures from the scene being recorded. In some cases, however, only static calibration videos may feasibly be captured. In some embodiments, to simulate the effect of camera motion in statically recorded videos, FPN map calibration may be completed by averaging denoising residue frames across multiple capture sessions with similar camera parameters. For example, 10-20 denoising residue frames from a single capture session may be averaged to obtain an FPN map, which may include some undesired image structures. Subsequently, FPN maps from, e.g., 7-10 different capture sessions may then be averaged to obtain a high quality FPN map in which the undesired image structures from each individual FPN map are averaged out.

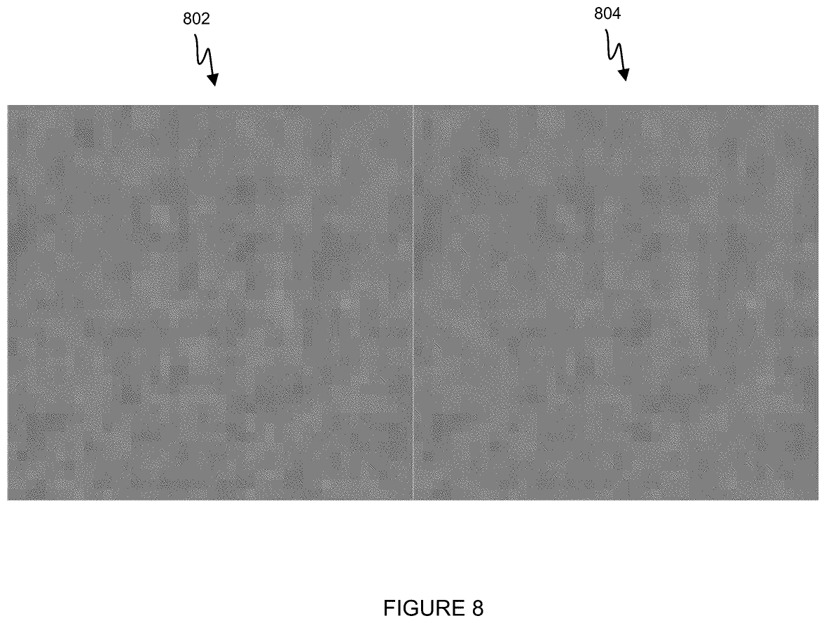

FIG. 8 illustrates example calibrated FPN maps 802 and 804 in accordance with this disclosure. The example calibrated FPN map 802 is obtained from static calibration videos recorded across multiple capture sessions with similar camera parameters, where there is substantially no camera motion between each capture session, as discussed above. The example calibrated FPN map 804 is obtained from a single calibration video recorded in a single capture session in which there is camera motion (e.g., as discussed above with respect to the embodiments of FIGS. 3-6).

As illustrated in FIG. 8, the example calibrated FPN map 802 is comparable to the example calibrated FPN map 804 in quality. Any undesired image structures from the multiple capture sessions are averaged out in the final example calibrated FPN map 802.

In other embodiments, FPN map calibration may be performed by capturing a completely dark calibration video. In this case, the calibration video may be static without degrading the resultant calibrated FPN map since the calibration video is completely dark, and thus there should be no undesired image structures in the calibrated FPN map.

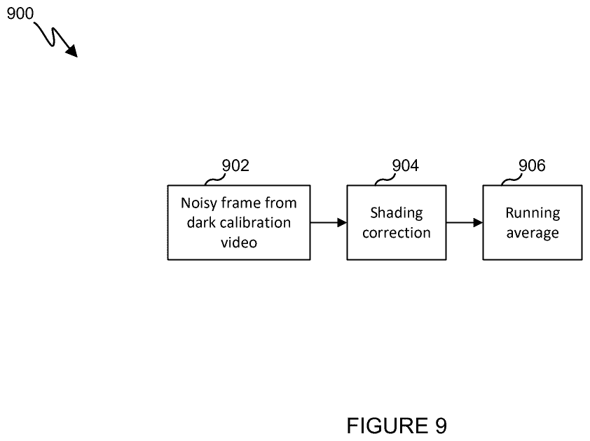

FIG. 9 illustrates an example FPN map calibration process 900 using a dark calibration video in accordance with this disclosure. For case of explanation, the process 900 is described as involving the use of the electronic device 101 in the network configuration 100 of FIG. 1. However, the process 800 may be used with any other suitable electronic device (such as the server 106) or a combination of devices (such as the electronic device 101 and the server 106) and in any other suitable system(s).

Noisy calibration video frames 902 are captured using the image sensor in a completely dark environment (e.g., in a completely dark room, or with the camera lens covered). Each noisy calibration video frame 902 is passed to the shading correction procedure 904 to obtain a shade-corrected calibration video frame. The shading correction procedure 904 may be the same as the shading correction procedure 310 of FIG. 3. The shade-corrected calibration video frames are then aggregated at block 906 by, e.g., performing a running average, to obtain a calibrated FPN map. The running average of block 906 may be the same as the running average of block 316 of FIG. 3. Because the calibration video is completely dark, there will be no undesired image structures in the resultant calibrated FPN map.

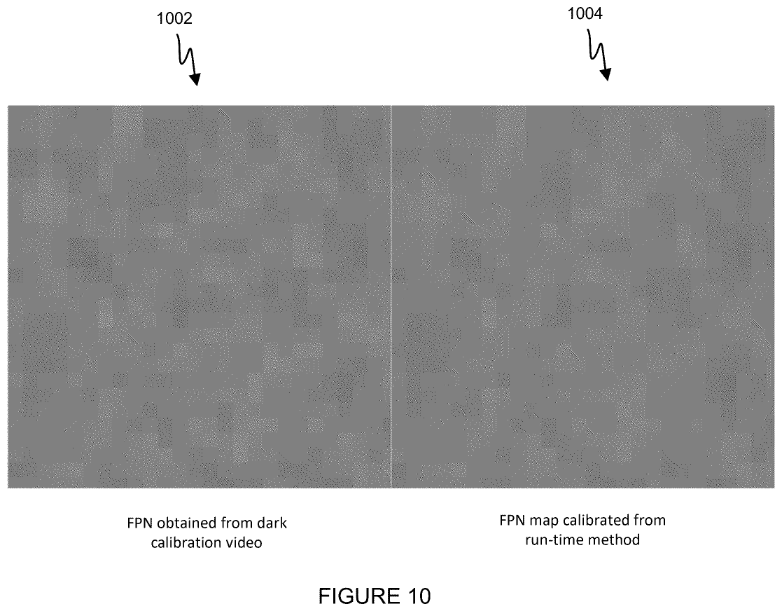

FIG. 10 illustrates example calibrated FPN maps 1002 and 1004 in accordance with this disclosure. The example calibrated FPN map 1002 is obtained from a calibration video recorded in a completely dark environment (e.g., in a completely dark room, or with the camera lens covered). There may be substantially no camera motion during the capture session. The example calibrated FPN map 1004 is obtained from a calibration video that contains objects in the recorded scene (i.e., not in a dark environment), and that is recorded in a capture session in which there is camera motion (e.g., as discussed above with respect to the embodiments of FIGS. 3-6).

As illustrated in FIG. 10, the example calibrated FPN map 1002 is comparable to the example calibrated FPN map 1004 in quality. There are no undesired image structures in the calibration video due to the completely dark environment, and thus there are no undesired image structures in the final example calibrated FPN map 1002.

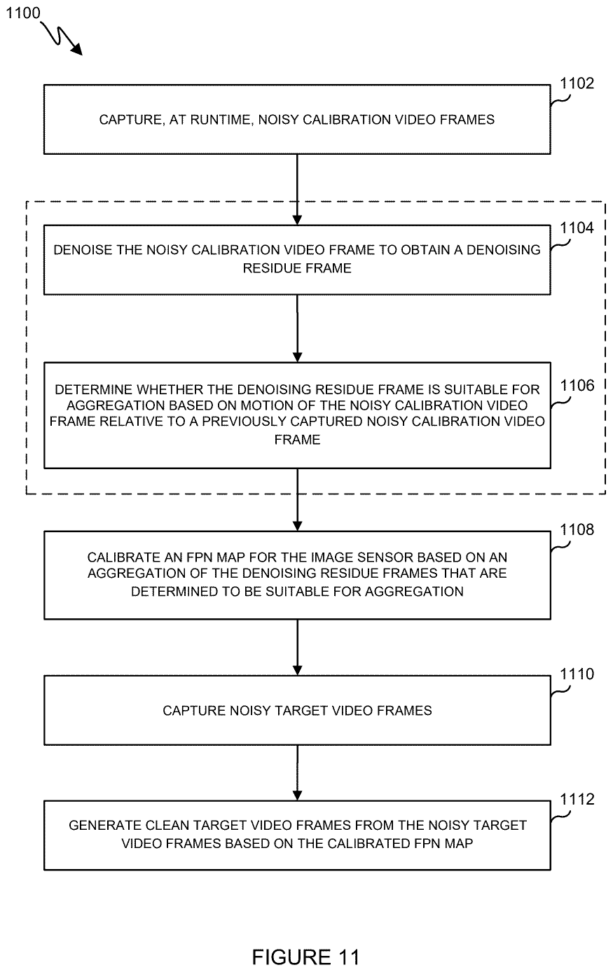

FIG. 11 illustrates an example method 1100 for FPN calibration and correction for video noise reduction in accordance with this disclosure. For case of explanation, the method 1100 shown in FIG. 11 is described as being performed using the electronic device 101 in the network configuration 100 of FIG. 1. However, the method 1100 could be performed using any other suitable device(s), such as the server 106, and in any other suitable system(s).

At block 1102, an image sensor of the electronic device captures, at runtime, noisy calibration video frames.

For each noisy calibration video frame captured at block 1102, a processor of the electronic device denoises the noisy calibration video frame to obtain a denoising residue frame (block 1104). In some embodiments, to denoise each noisy calibration video frame the processor generates a clean calibration video frame from the noisy calibration video frame using a video denoising pipeline. The processor then subtracts the clean calibration video frame from the noisy calibration video frame to obtain the denoising residue frame.

The processor then determines whether the denoising residue frame is suitable for aggregation based on motion of the noisy calibration video frame relative to a previously captured noisy calibration video frame (block 1106).

In some embodiments of block 1106, for each noisy calibration video frame the processor first applies a shading correction to the denoising residue frame to obtain a shade-corrected residue frame, and then determines whether the shade-corrected residue frame (rather than the denoising residue frame) is suitable for aggregation based on the motion of the noisy calibration video frame relative to the previously captured noisy calibration video frame.

In such embodiments, to apply the shading correction for each denoising residue frame, the processor downsamples the denoising residue frame, applies an averaging filter to the downsampled denoising residue frame and obtains a filtering result, upsamples the filtering result to an original resolution of the denoising residue frame to obtain an estimated shade, and subtracts the estimated shade from the denoising residue frame.

In some embodiments of block 1106, to determine whether the denoising residue frame corresponding to each noisy calibration video frame is suitable for aggregation, the processor obtains information on motion of the image sensor based on motion sensor data from the electronic device, and determines, based on the information on the motion of the image sensor, that an amount of the motion of the image sensor since capture of the previously captured noisy calibration video frame exceeds a predetermined motion threshold.

In some embodiments of block 1106, to determine whether the denoising residue frame corresponding to each noisy calibration video frame is suitable for aggregation, the processor determines that the noisy calibration video frame is captured in a different recording session than the previously captured noisy calibration video frame.

In some embodiments of block 1106, to determine whether the denoising residue frame corresponding to each noisy calibration video frame is suitable for aggregation, the processor determines that the noisy calibration video frame and the previously captured noisy calibration video frame are captured in a sufficiently dark environment.

Next, the processor calibrates an FPN map for the image sensor based on an aggregation of the denoising residue frames that are determined to be suitable for aggregation (block 1108). This may include computing a running average of the denoising residue frames that are determined to be suitable for aggregation to aggregate those denoising residue frames.

After the calibrating of block 1108, the image sensor captures noisy target video frames at runtime (block 1110).

Finally, the processor generates clean target video frames from the noisy target video frames based on the calibrated FPN map (block 1112). In some embodiments this includes, for each noisy target video frame, subtracting the calibrated FPN map from the noisy target video frame to obtain an FPN-corrected target video frame, and generating a clean target video frame from the corrected target video frame using the video denoising pipeline.

In some embodiments of block 1112, the processor first matches first FPN statistics of the calibrated FPN map with second FPN statistics of the noisy target video frames to obtain a current FPN map, then subtracts the calibrated FPN map from the noisy target video frame to obtain the FPN-corrected target video frame. Matching the first FPN statistics of the calibrated FPN map with the second FPN statistics of the noisy target video frames may be done by multiplying the first FPN statistics by a scaling factor.

Although FIG. 11 illustrates one example of a method 1100 for FPN calibration and correction for video noise reduction, various changes may be made to FIG. 11. For example, while shown as a series of steps, various steps in FIG. 11 could overlap, occur in parallel, occur in a different order, or occur any number of times (including zero times).

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method of fixed pattern noise (FPN) reduction performed by an electronic device, the method comprising:
capturing, at runtime by an image sensor of the electronic device, noisy calibration video frames;
for each noisy calibration video frame:
denoising, by a processor of the electronic device, the noisy calibration video frame to obtain a denoising residue frame, and
determining, by the processor, whether the denoising residue frame is suitable for aggregation based on motion of the noisy calibration video frame relative to a previously captured noisy calibration video frame;
calibrating, by the processor, an FPN map for the image sensor based on an aggregation of the denoising residue frames that are determined to be suitable for aggregation;
after the calibrating, capturing, by the image sensor, noisy target video frames; and
generating, by the processor, clean target video frames from the noisy target video frames based on the calibrated FPN map.

2. The method of claim 1, wherein the aggregation of the denoising residue frames that are determined to be suitable for aggregation comprises computing, by the processor, a running average of the denoising residue frames that are determined to be suitable for aggregation.

3. The method of claim 1, wherein:
for each noisy calibration video frame, the denoising comprises:
generating, by the processor, a clean calibration video frame from the noisy calibration video frame using a video denoising pipeline; and
subtracting, by the processor, the clean calibration video frame from the noisy calibration video frame to obtain the denoising residue frame, and
generating the clean target video frames from the noisy target video frames based on the calibrated FPN map comprises, for each noisy target video frame:
subtracting, by the processor, the calibrated FPN map from the noisy target video frame to obtain an FPN-corrected target video frame; and
generating, by the processor, a clean target video frame from the corrected target video frame using the video denoising pipeline.

4. The method of claim 3, further comprising:
matching first FPN statistics of the calibrated FPN map with second FPN statistics of the noisy target video frames to obtain a current FPN map,
wherein generating the clean target video frames from the noisy target video frames based on the calibrated FPN map comprises, for each noisy target video frame, subtracting, by the processor, the current FPN map from the noisy target video frame to obtain the FPN-corrected target video frame.

5. The method of claim 4, wherein matching the first FPN statistics of the calibrated FPN map with the second FPN statistics of the noisy target video frames comprises multiplying the first FPN statistics by a scaling factor.

6. The method of claim 1, further comprising, for each noisy calibration video frame:
applying, by the processor, a shading correction to the denoising residue frame to obtain a shade-corrected residue frame,
wherein determining, by the processor, whether the denoising residue frame is suitable for aggregation comprises determining, by the processor, whether the shade-corrected residue frame is suitable for aggregation based on the motion of the noisy calibration video frame relative to the previously captured noisy calibration video frame.

7. The method of claim 6, wherein applying the shading correction comprises, for each denoising residue frame:
downsampling, by the processor, the denoising residue frame;
applying, by the processor, an averaging filter to the downsampled denoising residue frame and obtaining a filtering result;
upsampling, by the processor, the filtering result to an original resolution of the denoising residue frame to obtain an estimated shade; and
subtracting, by the processor, the estimated shade from the denoising residue frame.

8. The method of claim 1, wherein, for each noisy calibration video frame, determining whether the denoising residue frame is suitable for aggregation comprises:
obtaining, by the processor, information on motion of the image sensor based on motion sensor data from the electronic device; and
determining, by the processor based on the information on the motion of the image sensor, that an amount of the motion of the image sensor since capture of the previously captured noisy calibration video frame exceeds a predetermined motion threshold.

9. The method of claim 1, wherein, for each noisy calibration video frame, determining whether the denoising residue frame is suitable for aggregation comprises determining, by the processor, that the noisy calibration video frame is captured in a different recording session than the previously captured noisy calibration video frame.

10. The method of claim 1, wherein, for each noisy calibration video frame, determining whether the denoising residue frame is suitable for aggregation comprises determining, by the processor, that the noisy calibration video frame and the previously captured noisy calibration video frame are captured in a sufficiently dark environment.

11. An electronic device for performing fixed pattern noise (FPN) reduction, the electronic device comprising:
an image sensor configured to capture, at runtime, noisy calibration video frames; and
a processor operably coupled with the image sensor, the processor configured to:
for each noisy calibration video frame:
denoise the noisy calibration video frame to obtain a denoising residue frame; and
determine whether the denoising residue frame is suitable for aggregation based on motion of the noisy calibration video frame relative to a previously captured noisy calibration video frame, and
calibrate an FPN map for the image sensor based on an aggregation of the denoising residue frames that are determined to be suitable for aggregation,
wherein the image sensor is further configured to, after the calibrating, capture noisy target video frames, and
wherein the processor is further configured to generate clean target video frames from the noisy target video frames based on the calibrated FPN map.

12. The electronic device of claim 11, wherein the processor is further configured to compute a running average of the denoising residue frames that are determined to be suitable for aggregation to aggregate the denoising residue frames that are determined to be suitable for aggregation.

13. The electronic device of claim 11, wherein:
for each noisy calibration video frame, the processor configured to denoise the noisy calibration video frame is further configured to:
generate a clean calibration video frame from the noisy calibration video frame using a video denoising pipeline; and
subtract the clean calibration video frame from the noisy calibration video frame to obtain the denoising residue frame, and
the processor configured to generate the clean target video frames from the noisy target video frames based on the calibrated FPN map is further configured to, for each noisy target video frame:
subtract the calibrated FPN map from the noisy target video frame to obtain an FPN-corrected target video frame; and
generate a clean target video frame from the corrected target video frame using the video denoising pipeline.

14. The electronic device of claim 13, wherein:
the processor is further configured to match first FPN statistics of the calibrated FPN map with second FPN statistics of the noisy target video frames to obtain a current FPN map, and
the processor configured to generate the clean target video frames from the noisy target video frames based on the calibrated FPN map is further configured to, for each noisy target video frame, subtract the current FPN map from the noisy target video frame to obtain the FPN-corrected target video frame.

15. The electronic device of claim 14, wherein the processor configured to match the first FPN statistics of the calibrated FPN map with the second FPN statistics of the noisy target video frames is further configured to multiply the first FPN statistics by a scaling factor.

16. The electronic device of claim 11, wherein:
the processor is further configured to, for each noisy calibration video frame, apply a shading correction to the denoising residue frame to obtain a shade-corrected residue frame, and
the processor configured to determine whether the denoising residue frame is suitable for aggregation is configured to determine whether the shade-corrected residue frame is suitable for aggregation based on the motion of the noisy calibration video frame relative to the previously captured noisy calibration video frame.

17. The electronic device of claim 16, wherein the processor configured to apply the shading correction is further configured to, for each denoising residue frame:
downsample the denoising residue frame;
apply an averaging filter to the downsampled denoising residue frame and obtain a filtering result;
upsample the filtering result to an original resolution of the denoising residue frame to obtain an estimated shade; and
subtract the estimated shade from the denoising residue frame.

18. The electronic device of claim 11, wherein the processor configured to determine, for each noisy calibration video frame, whether the denoising residue frame is suitable for aggregation is configured to:
obtain information on motion of the image sensor based on motion sensor data from the electronic device; and
determine, based on the information on the motion of the image sensor, that an amount of the motion of the image sensor since capture of the previously captured noisy calibration video frame exceeds a predetermined motion threshold.

19. The electronic device of claim 11, wherein the processor configured to determine, for each noisy calibration video frame, whether the denoising residue frame is suitable for aggregation is configured to determine that the noisy calibration video frame is captured in a different recording session than the previously captured noisy calibration video frame.

20. The electronic device of claim 11, wherein the processor configured to determine, for each noisy calibration video frame, whether the denoising residue frame is suitable for aggregation is configured to determine that the noisy calibration video frame and the previously captured noisy calibration video frame are captured in a sufficiently dark environment.
